(19) United States
(12) Patent Application Publication
(10) Pub. No.: US 2013/0077207 A1
(43) Pub. Date: Mar. 28, 2013

(54) POROUS CARBON WITH HIGH VOLUMETRIC CAPACITY, FOR DOUBLE-LAYER CAPACITORS, AND PRODUCTION METHOD

(71) Applicant: SGL CARBON SE, Wiesbaden (DE)

(72) Inventor: THOMAS KIRSCHBAUM, BIBERBACH (DE)

(73) Assignee: SGL CARBON SE, WIESBADEN (DE)

(21) Appl. No.: 13/680,500

(22) Filed: Nov. 19, 2012

Related U.S. Application Data
(63) Continuation of application No. PCT/EP2011/057251, filed on May 5, 2011.

(30) Foreign Application Priority Data
May 17, 2010 (DE) 10 2010 029 034.3

(51) Int. Cl. H01G 11/34; H01B 1/04; H01G 9/00

(52) U.S. Cl. CPC H01G 11/34; H01G 9/155; H01B 1/04; B82Y 99/00
USPC 361/502; 264/42; 428/219; 977/948

(57) ABSTRACT

An activated, porous carbon has a specific BET surface area of between 1400 and 1900 m²/g, with at least 80% of all of the pores, and preferably all of the pores, of the carbon having an average diameter of between 0.3 and 0.9 nm. The novel carbon is particularly suitable for use as an electrode in a double-layer capacitor. The carbon is obtained by a process that includes the following steps: a) producing a mixture of a green coke, a base, and a hydrophilic polymer which is chemically inert towards the base, b) pressing the mixture produced in step a), to form a compact, and c) activating the compact produced in step b).

### CROSS-REFERENCE TO RELATED APPLICATION

This application is a continuation, under 35 U.S.C. §120, of copending international application No. PCT/EP2011/057251, filed May 5, 2011, which designated the United States; this application also claims the priority, under 35 U.S.C. §119, of German patent application DE 10 2010 029 034.3, filed May 17, 2010; the prior applications are herewith incorporated by reference in their entirety.

### BACKGROUND OF THE INVENTION

### Field of the Invention

The present invention relates to an activated, porous carbon having a defined specific BET surface area and a defined pore distribution that may be used as an adsorption material or as an electrode, and particularly as an electrode in a double-layer capacitor.

Because of its high porosity, activated carbon, or activated charcoal, is frequently used as an adsorption material, particularly to remove unwanted coloring agents, flavoring substances and/or odorants from gases and liquids, for example in waste water treatment or air purification. In such cases, the activated carbon may be in granulate, powder or pellet form depending on the particular application.

Besides this use, and also because of its high porosity, activated carbon also lends itself well to use as an electrode material, for example in double-layer capacitors, which are also called supercapacitors and are becoming increasingly important due to their high energy density. Such double-layer capacitors are made with two electrodes, separated from one another by a separator, and each of which being coated with electrolyte. In order to be able to store high energy densities, double-layer capacitors need electrode material with the highest possible volumetric capacity. However, the volumetric capacity cannot be increased by increasing the specific surface area of the electrode or carbon material indefinitely, because increasing the specific surface area simultaneously reduces the density of the activate carbon, thus again resulting in a loss of volumetric capacitance.

United States Patent Application Publication US 2007/238612 A1 and its counterparts WO 02/054422 A1 and German patent DE 101 97 141 B4 describe the use of an alkali-activated carbon as the electrode in an electrical double-layer capacitor. There, the alkali-activated carbon contains pores of a first group of pores having a pore diameter D not exceeding 2 nm, pores of a second group of pores having a pore diameter D greater than 2 nm but not exceeding 10 nm, and pores of a third group of pores having a pore diameter D greater than 10 but not exceeding 300 nm. The volume of the pores in the first group of pores constitutes more than 60% of the total volume of all pores of the first, second and third groups combined, and the volume of the pores in the second group of pores constitutes more than 8% of the total volume of all pores of the first, second and third groups combined, and wherein the volume of the pores in the first group of pores constitutes is greater than 0.10 to 0.44 ml/g, and the volume of the pores in the second group of pores is greater than 0.01 to 0.20 ml/g. The specific surface area of the activated carbon is about 500 to 1150 m²/g. Whereas the pores in the first group of pores are intended particularly to promote the development of electrical capacitance, the pores in the second group of pores are intended to ensure that ions are diffused in the carbon and that the carbon is impregnated with electrolytic solution, and the pores in the third group of pores are intended to promote the impregnation of the carbon with electrolytic solution.

In this context, the capacitance density or volumetric capacitance of a double-layer capacitor produced using electrodes made from such a carbon should become greater as the fraction of pores in the first group of pores is increased up to a value of 80% relative to the total number of all pores in the carbon, but if the fraction of pores in the first group of pores is increased above 80% relative to the total number of all pores the volumetric capacitance should begin to fall again. A double-layer capacitor produced using electrodes made from such a carbon should have a capacitance density or volumetric capacitance from 30 to 41 F/cm³ carbon. However, the energy density that can be stored by double-layer capacitors produced using electrodes made from such a carbon is in need of improvement.

Accordingly, in order to produce double-layer capacitors that are capable of storing greater energy density, an activated carbon that is capable of lending double-layer capacitors increased volumetric capacitance is desirable.

### SUMMARY OF THE INVENTION

It is accordingly an object of the invention to provide a porous carbon material and a double-layer capacitor produced therewith which overcome the above-mentioned disadvantages of the heretofore-known devices and methods of this general type and which provides for easily producible, activated porous carbon having greater volumetric capacitance than the carbons known from the prior art, and which is therefore very well suited for use as electrode material in double-layer capacitors and may be used to produce double-layer capacitors that are capable of storing a particularly high energy density.

With the foregoing and other objects in view there is provided, in accordance with the invention, a composition of matter in the form of an activated, porous carbon having a specific BET surface area between 1,400 and 1,900 m²/g, wherein at least 80% of all pores in the carbon have an average diameter between 0.3 and 0.9 nm.

This solution is based on the surprising discovery that an activated, porous carbon with a defined BET surface area that is made up exclusively, or at least virtually exclusively, of micropores, but no or almost no mesopores or macropores, that is to say activated, porous carbon having a specific BET surface area between 1,400 and 1,900 m²/g, wherein at least 80% of all pores in the carbon have an average diameter between 0.3 and 0.9 nm, exhibits particularly high specific and volumetric capacitances and, when used as electrode material in a double-layer capacitor for example, results in layer capacitors that are capable of storing a particularly high energy density.

The specific surface area of the activated carbon cited in the preceding text is measured according to the present patent application with a device for measuring surface area and pores with the brand name AUTOSORB-6 that is commercially available from Quantachrome Corporation, Boynton Beach, Fla., or from Quantachrome GmbH & Co. KG, Odelzhausen, Germany. The AUTOSORB® measures nitrogen isotherms at 77 K and the samples for measurement are baked out for 1 hour in a vacuum at 350° C. Analysis is carried out using the software AS1 Win, Version 2.01, which is also marketed by Quantachrome Corporation.

In order to measure the pore radius distribution, from which the fraction of the total number of all pores having an average diameter between 0.3 and 0.9 nm is determined according to the present application, a measuring device for surface area and pore analysis is used that has the brand name NOVA 2200, and is also marketed commercially by the company Quantachrome Corporation. With that instrument, carbon dioxide isotherms are measured at 0° C., and the samples for measurement are baked out for 1 hour in a vacuum at 350° C. The average pore radii are calculated according to the “Nonlocal Density Functional Theory” (NLDFT) and the Monte Carlo method.

According to the invention, at least 80% of all pores of the carbon have an average diameter between 0.3 and 0.9 nm. Especially high volumetric and also specific capacitances are obtained particularly if at least 90% of all pores, preferably at least 95% of all pores, particularly preferably at least 99% of all pores and most preferably all of the pores in the carbon have an average diameter between 0.3 and 0.9 nm.

In a refinement of the inventive thought, it is suggested that the activated, porous carbon may have a total pore volume between 0.7 and 1.2 cm³/g, wherein in particular activated, porous carbon having a total pore volume between 0.7 and 1.0 cm³/g, and particularly preferably having a total pore volume between 0.8 and 0.9 cm³/g exhibits particularly good properties for technical application purposes. According to the present patent application, the total pore volume is measured with a measuring device for surface area and pore analysis with the brand name AUTOSORB-6, which is marketed commercially by Quantachrome Corporation. There, nitrogen isotherms are measured at 77 K and the samples for measurement are baked out for 1 hour in a vacuum at 350° C. Analysis is carried out using the software AS1 Win, Version 2.01, which is also marketed by Quantachrome Corporation.

As was explained earlier, activated, porous carbon with the stated specific surface area and pore characteristics has particularly high specific capacitance and particularly high volumetric capacitance.

The specific capacitance of the carbon preferably lies between 130 and 150 F/g, whereas the volumetric capacitance of the carbon preferably lies between 80 and 100 F/cm³.

The stated capacitances of the carbon, that is to say the specific capacitance and the volumetric capacitance, refer to the capacitance relating to a single electrode produced from the carbon, which according to the present invention is measured as follows by galvanostatic cyclization: electrodes in the form of round pellets having a diameter of 10 mm and a mass of 10 mg each are formed from the activated carbon, after which the electrical capacitance thereof is measured with a “Whatman” glass fiber separator having a thickness of 30 μm at 2.3 V and a charge current of 500 mA/g in a Swagelok cell with 1 M tetraethyl ammoniumtetrafluoroborate in acetonitrile as the electrolyte, and the specific capacitance and volumetric capacitance are calculated therefrom.

The previously described, activated porous carbon may particularly be produced by process based on alkali activation that comprises the following steps:
a) Producing a mixture of a green coke, a base and a hydrophilic polymer that is chemically inert with respect to the base,
b) compacting the mixture produced in step a) to form a compacted pellet, and
c) activating the compacted pellet produced in step b).

With this process, it is possible to produce a surprisingly activated porous carbon, in particularly using green coke as well, that has exclusively or at least almost exclusively micropores with the characteristics profile described in the preceding. A further advantage of this process consists in that the formation and distribution of the reduction product of the base, such as vapor-phase potassium is effectively avoided in the apparatus in which the activation is carried out. This is firstly because a compacted pellet, not a powder, is processed during and after the activation, and the pellet has a low surface area per weight compared with powder, with the result that no potassium vapor escapes therefrom at the temperatures that prevail during the activation. Secondly, the addition of the hydrophilic polymer when the mixture is being compacted results in the production of a dense compacted pellet that remains dimensionally stable particularly in the high temperatures that prevail during the activation, because the polymer functions surprisingly as a binding agent, that is to say it binds the green coke particles and the base particles together. Consequently, the compacted pellet is reliably prevented from disintegrating even under the high temperature conditions that are present during the activation. The stability of the compacted pellets enables the reagents to come into deep contact with each other during the activation, which in turn assures more intense reactivity and more of the base is used during the activation, so that a comparatively small quantity of the base needs to be used in this process. Moreover, in this process the activation does not have to be carried out in a gas stream such as a nitrogen stream; instead, inertization is assured automatically during the activation by the gases from the pyrolysis of the green coke and the hydrophilic polymer, so that potassium vapor present in the apparatus cannot be propagated in the apparatus. Consequently, it is possible to avoid corrosion of the apparatus in which the activation is carried out. A further advantage of this process is the freely selectable size of the compacted pellet, which lends the process a high degree of flexibility. It is also possible in particular to produce very large panels by this process, which enables the furnace chamber to be charged economically.

A further object of the present invention is an activated porous carbon that is obtainable by the process described in the preceding, that is to say an activated porous carbon that is obtainable by a process comprising the following steps:
a) Producing a mixture of a green coke, a base and a hydrophilic polymer that is chemically inert with respect to the base,
b) compacting the mixture produced in step a) to form a compacted pellet, and
c) activating the compacted pellet produced in step b).

As was explained in the preceding, a carbon that is obtainable by this process has a specific BET surface area between 1,400 and 1,900 m²/g, and contains exclusively or at least virtually exclusively micropores with an average diameter between 0.3 and 0.9 nm, that is to say at least 80%, preferably at least 90%, more preferably at least 95%, especially preferably at least 99%, and most preferably 100% of all pores have an average diameter between 0.3 and 0.9 nm. Consequently, this activated carbon is characterized by a high specific capacitance of between 130 and 150 F/g for example, and a high volumetric capacitance of between 80 and 100 F/cm³ for example.

For the purposes of the present invention, the hydrophilic polymer used in step a) of the process is understood to be a polymer that is liquid at 23° C. and has rate of solubility in water at 23° C. of 10 g/l, or a polymer that is solid at 23° C. and has a contact angle with respect to water of less than 90°.

The term polymer for the purposes of the present invention also includes oligomers as well as polymers in the narrower sense.

For the purposes of the present invention, a polymer that is chemically inert with regard to the base used is understood to be a polymer that does not react with the base, and in particular does not undergo decomposition, particularly no chain shortening, if it is in contact with the base for 24 hours at 200° C. The chemically inert polymer also does not exhibit any loss of binding properties if it is in contact with the base for 24 hours at 200° C.

Process steps a), b) and c) are preferably carried out immediately consecutively, that is to say with no other intermediate steps therebetween, that is to say the mixture produced in process step a) and also the compacted pellet produced in step b) undergo process steps b) and c) respectively without any intermediate steps, particularly no dehydration and/or granulation step. In this way, it is possible to produce activated carbon having the previously described advantageous properties simply, quickly and economically.

According to the invention, any hydrophilic oligomer or polymer that is chemically inert with respect to the base used may be used in process step a). Good results are obtained for example if a polyether, or preferably a polyether polyol is used as the hydrophilic polymer.

In a refinement of the inventive thought, it is suggested to use a polyether polyol having the following general formula I as the hydrophilic polymer in process step a):

HO(—R—O—)ₙH (I),

wherein
n is a whole number between 2 and 100,000, preferably between 2 and 1,000, and even more preferably between 100 and 600, and
R is a linear or branched-chain alkylene group, substituted or not with one or more hydroxyl group(s), preferably a C₁-C₁₅ alkylene group preferably substituted or not with one or more hydroxyl group(s), and particularly preferably a C₁-C₁₀ alkylene group preferably substituted or not with one or more hydroxyl group(s). All these polyether polyols are chemically inert with respect to common bases and exhibit sufficient hydrophilic properties for the purposes of the process.

Particularly preferred polyether polyols according to general formula I are those with a C₁-C₆ alkylene group, substituted or not with one or more hydroxyl group(s), the substances used as radical R are therefore selected from the group including polymethylene glycol, polyethylene glycol, polypropylene glycol, polybutylene glycol, polypentylene glycol, polyhexylene glycol, polyglycerins and any mixtures of two or more of the cited compounds. Polyglycerins that are particularly suitable for the purposes of the present invention are such that have the following general formula II:

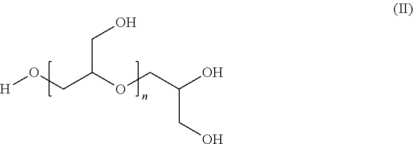

wherein n is a whole number between 2 and 100,000, preferably between 2 and 1,000, and even more preferably between 100 and 600.

According to a further particularly preferred embodiment of the present invention, polypropylene glycol and/or polyethylene glycol is used as the hydrophilic polymer in process step a), wherein liquid polypropylene glycol and/or polyethylene glycol and particularly polyethylene glycol with a weight-average molecular weight (Mw) from 200 to 600 g/mol has proven particularly suitable. If solid polypropylene glycol and/or polyethylene glycol is used, it is preferably used in the form of a fine powder having an average particle diameter between 0.1 and 1,000 μm, particularly preferably with an average particle diameter between 0.5 and 50 μm, and especially preferably with an average particle diameter between 1 and 10 μm, so that the solid polypropylene glycol and/or polyethylene glycol may be mixed homogeneously with the green coke. In keeping with the standard definition of this parameter, the average particle diameter is understood to be the d₅₀ value, that is to say the particle diameter value below which 50% of the particles present fall, in other words, the particle diameter of 50% of all the particles present is smaller than the d₅₀ value.

Particularly in the case that a liquid hydrophilic polymer is used in process step a), it is preferred to mix the hydrophilic polymer with the green coke first, before adding the base and mixing it with the mixture produced in this way, in order to prevent the base from dissolving in the polymer. An intensive mixer is preferably used as the mixer for this purpose.

In general, all bases that lend themselves to an oxidative chemical activation of carbon may be used in process step a), wherein alkali metal hydroxides and alkali metal carbonates are particularly suitable for this purpose, such as preferably lithium hydroxide, sodium hydroxide, sodium carbonate and potassium carbonate, and most particularly potassium hydroxide.

If the base is solid at room temperature, which is preferred, the base too is preferably added in the form of a powder, wherein the average particle diameter of the base is preferably between 0.1 and 1,000 μm, and particularly preferably between 0.5 and 100 μm.

In principle, all types of green coke may be used in process step a), that is to say all types of non-calcined coke with 10 to 15% volatile fractions, such as isotropic coke, electrode coke and needle coke, powder-form green coke having an average particle between 0.1 and 1,000 μm being particularly preferred. The actually preferred particle diameter of the green coke used in process step a) depends on the nature of the subsequent application of the activated carbon. For example, whereas average particle diameters of about 500 μm are preferred for its use as adsorption material, if it is to be used as electrode material a smaller particle diameter is preferred, particularly an average particle diameter between 0.5 and 50 μm, and particularly preferably an average particle diameter between 1 and 10 μm. If the activated carbon is to be used in a double-layer capacitor, the average particle diameter of the green coke used in process step a) should preferably not exceed 5 to 10 μm.

It has also proven advantageous for the purposes of the present invention of the powder-form green coke used in process step a) has no porosity, or only very low porosity, less than 10 m²/g.

In general, the individual components may be used in any ratio relative to each other in process step a), although the degree of activation of the carbon is adjusted via the base content, with the proviso that a higher base content in the mixture produced in process step a) results in the specific surface area of the activated carbon being increased, whereas the dimensional stability of the compacted pellet produced in process step b) is adjusted via the content of hydrophilic polymer, with the proviso that a higher polymer content results in greater dimensional stability of the compacted pellet. For this reason, it is preferred that the hydrophilic polymer constitute 3 to 10% by weight of the mixture, whereas the proportion of green coke to base is preferably 1:1.5 to 1:2.

Taking these trends into account, in a refinement of the inventive concept it is suggested to produce a mixture in process step a) that contains 20 to 50% by weight green coke, 1 to 15% by weight hydrophilic polymer and 35 to 79% by weight base, preferably 25 to 40% by weight green coke, 2 to 10% by weight hydrophilic polymer and 50 to 73% by weight base, and particularly preferably 30 to 35% by weight green coke, 3 to 7% by weight hydrophilic polymer and 58 to 67% by weight base.

In a particularly preferred embodiment of the present invention, the mixture produced in process step a) contains 25 to 40% by weight green coke, 2 to 10% by weight polyethylene glycol with a Mw from 200 to 600 g/mol, and 50 to 73% by weight potassium hydroxide, and particularly preferably 30 to 35% by weight green coke, 3 to 7% by weight polyethylene glycol with a Mw from 200 to 600 g/mol, and 58 to 67% by weight potassium hydroxide. Under these conditions, it is possible to obtain activated carbon having a BET surface area between 1,400 and 1,900 m²/g with the process.

In process step b) according to the invention, the mixture produced in process step a) is compacted to form a compacted pellet. For the purposes of the present invention, a compacted pellet is understood to a compacted body with a longest dimension, that is to say in the case of an at least essentially spherical compacted pellet the diameter, or in the case of a polygon a length of at least 50 mm, preferably of at least 100 mm, particularly preferably of at least 1 cm and most particularly preferably of at least 10 cm. An example of such is a cuboid compacted pellet having both a length and a width of about 50 cm.

Generally, the compacting in process step b) may be carried out using any suitable compacting pressure, although it should be noted that as the pressure increases so the density of the compacted pellet also increases and the maximum furnace charge for activation is thus increased. For this reason, the compacting in process step b) is preferably carried out in such manner that the mixture produced in process step a) is compacted to yield a compacted pellet having a density of at least 1 g/cm³, preferably a density of at least 1.25 g/cm³, particularly preferably a density of at least 1.5 g/cm³, and especially preferably a density of at least 1.7 g/cm³.

For example, with a compacting pressure of 100 kg/cm² it is possible to obtain a compacted pellet having a density of about 1 g/cm³, whereas with a compacting pressure of 5 tons/cm² it is possible to produce compacted pellets having a density of about 1.7 g/cm³. For this reason, the compacting in process step b) is preferably carried out in a die press with a pressure of at least 100 kg/cm².

The success of the heat treatment according to process step c) depends primarily on the maximum temperature reached during the heat treatment and the time for which this maximum temperature is maintained. According to the invention, the heat treatment of the compacted pellet in process step c) is carried out at a maximum temperature from 500 to 1,500° C., this being preferably set to 700 to 1,000° C., particularly preferably 700 to 900° C., and especially preferably 850 to 900° C.

In this context, it is preferred that the maximum temperature be maintained for at least 0.5 hour, particularly preferably for at least 1 hour, especially preferably for at least 2 hours, and most preferably for at least 3 hours.

The preferred heating rate depends on the quantity of material in the furnace, slower heating rates being more appropriate for ensuring uniform heating of larger material quantities than of smaller material quantities. Depending on the quantity of material in the furnace, generally good results are obtained if the heating rate is 1 to 100° C./min, preferably 2 to 50° C./min, and particularly preferably 5 to 25° C./min.

In a refinement of the inventive thought, it is suggested to cool the compacted pellet to room temperature quickly after maintaining the maximum temperature in process step c), and this may be carried out expediently by first cooling the compacted pellet to about 150° C. in the furnace before preferably quenching it in water.

According to a further preferred embodiment of the present invention the activated compacted pellet is washed in a process step d) following the heat treatment, in order to remove impurities from the activated carbon. The washing operation preferably includes at least one washing step with a mineral acid such as hydrochloric acid or sulfuric acid, followed by repeated washing cycles with distilled water until neutrality is reached.

A further object of the present invention is the use of the activated carbon described in the preceding as adsorption material or an electrode, and preferably as an electrode in an electric double-layer capacitor (EDLC).

1. A composition of matter, comprising an activated, porous carbon having a specific BET surface area between 1,400 and 1,900 m²/g, wherein at least 80% of all pores in the carbon have an average diameter between 0.3 and 0.9 nm.

2. The activated, porous carbon according to claim 1, wherein at least 90% of all pores in the carbon have an average diameter between 0.3 and 0.9 nm.

3. The activated, porous carbon according to claim 1, wherein at least 99% of all pores in the carbon have an average diameter between 0.3 and 0.9 nm.

4. The activated, porous carbon according to claim 2, wherein all pores in the carbon have an average diameter between 0.3 and 0.9 nm.

5. The activated, porous carbon according to claim 1, wherein the carbon has a total pore volume between 0.7 and 1.2 cm³/g.

6. The activated, porous carbon according to claim 1, wherein the carbon has a total pore volume between 0.8 and 0.9 cm³/g.

7. The activated, porous carbon according to claim 1, wherein the carbon has a specific capacitance between 130 and 150 F/g, the specific capacitance relating to a single electrode produced from the carbon, and the specific capacitance is measured by galvanostatic cyclization by shaping electrodes into round pellets of the activated carbon having a diameter of 10 mm and a mass of 10 mg, and the electrical capacitance is measured with a “Whatman” glass fiber separator having a thickness of 30 μm at 2.3 V and a charge current of 500 mA/g in a Swagelok cell with 1 M tetraethyl ammonium tetrafluoroborate in acetonitrile as the electrolyte, and the specific capacitance is calculated therefrom.

8. The activated, porous carbon according to claim 1, wherein the carbon has a volumetric capacitance between 80 and 100 F/cm³, the volumetric capacitance relating to a single electrode produced from the carbon, and the volumetric capacitance is measured by galvanostatic cyclization by shaping electrodes into round pellets of the activated carbon having a diameter of 10 mm and a mass of 10 mg each, and the electrical capacitance thereof is measured with a “Whatman” glass fiber separator having a thickness of 30 μm at 2.3 V and a charge current of 500 mA/g in a Swagelok cell with 1 M tetraethyl ammonium tetrafluoroborate in acetonitrile as the electrolyte, and the volumetric capacitance is calculated therefrom.

9. A method of producing activated, porous carbon, the method which comprises the following steps:
a) producing a mixture of a green coke, a base, and a hydrophilic polymer that is chemically inert with respect to the base;
b) compacting the mixture produced in step a) to form a compacted pellet; and
c) activating the compacted pellet produced in step b), to thereby produce an activated, porous carbon according to claim 1.

10. The method according to claim 9, wherein step a) comprises using a polyether as the hydrophilic polymer.

11. The method according to claim 10, wherein the polyether is a polyether polyol according to the general formula I:
HO(—R—O—)ₙH,
wherein
n is a whole number between 2 and 100,000, and
R is a linear or branched-chain alkylene group, optionally substituted or not with one or more hydroxyl group(s).

12. The method according to claim 11, wherein n is a number between 100 and 600.

13. The method according to claim 11, wherein R is a C₁-C₁₅ alkylene group, optionally substituted or not with one or more hydroxyl groups.

14. The method according to claim 13, wherein R is a C₁-C₆ alkylene group, optionally substituted or not with one or more hydroxyl groups.

15. The method according to claim 9, wherein the hydrophilic polymer in step a) is selected from the group consisting of polymethylene glycol, polyethylene glycol, polypropylene glycol, polybutylene glycol, polypentylene glycol, polyhexylene glycol, polyglycerins and any mixtures of two or more of these compounds.

16. The method according to claim 16, wherein the hydrophilic polymer in step a) is one or more glycols selected from the group consisting of polypropylene glycol having a weight-average molecular weight from 200 to 600 g/mol and polyethylene glycol having a weight-average molecular weight from 200 to 600 g/mol.

17. The method according to claim 9, wherein step a) comprises first mixing the hydrophilic polymer with the green coke before the base is added to the mixture obtained in this way and mixed therewith.

18. The method according to claim 9, wherein step a) comprises forming a mixture containing 20 to 50% by weight green coke, 1 to 15% by weight hydrophilic polymer, and 35 to 79% by weight base.

19. The method according to claim 18, wherein the mixture contains 30 to 35% by weight green coke, 3 to 7% by weight hydrophilic polymer, and 58 to 67% by weight base.

20. The method according to claim 9, wherein step b) comprises one of both of the following steps: compacting in a die press with a pressure of at least 100 kg/cm²/or compacting the mixture produced in step a) to form a compacted pellet having a density of at least 1 g/cm³.

21. The method according to claim 9, wherein step c) comprises performing a heat treatment of the compacted pellet at a temperature from 500 to 1,500° C., and maintaining a maximum temperature during the heat treatment for at least 0.5 hours.

22. The method according to claim 21, which comprises carrying out the heat treatment in step c) at a temperature from 850 to 900° C. and for at least 3 hours.

23. In combination with an electrical double-layer capacitor, the activated, porous carbon according to claim 1 forming an adsorption material or an electrode in the double-layer capacitor.
